(19) United States
(12) Patent Application Publication
(10) Pub. No.: US 2020/0406892 A1
(43) Pub. Date: Dec. 31, 2020

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Kaijiang Yu, Wako-shi (JP)

(21) Appl. No.: 16/908,794

(22) Filed: Jun. 23, 2020

(30) Foreign Application Priority Data
Jun. 25, 2019 (JP) 2019-117055

(51) Int. Cl. B60W 30/095; B60W 30/18; B60W 30/14; B60W 40/04; B60W 10/20; G06K 9/00

(52) U.S. Cl. CPC B60W 30/0953; B60W 30/18163; B60W 30/143; B60W 40/04; B60W 2556/45; G06K 9/00798; G06K 9/00825; B60W 2554/4045; B60W 10/20

(57) ABSTRACT

A vehicle control device includes a driving controller. In a case in which the own vehicle is traveling in a third lane connected to a first lane of a main lane including at least the first lane and a second lane adjacent to the first lane and enters the first lane, the driving controller is configured to determine that the own vehicle is able to join the first lane when another vehicle traveling on a side of the own vehicle in the first lane is predicted to change a lane to the second lane, and determine that the own vehicle is not able to join the first lane when the other vehicle is predicted not to change the lane to the second lane and the other vehicle is not decelerating or accelerating. The driving controller is configured to control the own vehicle according to a determination result.

### CROSS-REFERENCE TO RELATED APPLICATION

Priority is claimed on Japanese Patent Application No. 2019-117055, filed Jun. 25, 2019, the content of which is incorporated herein by reference.

### BACKGROUND

### Field

The present invention relates to a vehicle control device, a vehicle control method, and a storage medium.

### Description of Related Art

In the related art, a vehicle control system in which, in a scenario in which an own vehicle joins in a main lane, the own vehicle accelerates to show an appeal to a target vehicle when the target vehicle is determined to be in a state indicative of willingness to allow the own vehicle to cut in front of it, and the own vehicle decelerates to show an appeal to the target vehicle when the target vehicle is determined to be in a state indicative of willingness to allow the own vehicle to cut behind it is disclosed (for example, Japanese Unexamined Patent Application, First Publication No. 2018-62300).

### SUMMARY

However, in the technology of the related art, a vehicle cannot join a main lane smoothly in some cases depending on a vehicle state of a joining destination.

The present invention is devised in view of such circumstances and an objective of the present invention is to provide a vehicle control device, a vehicle control method, and a storage medium capable of causing a vehicle to join a main lane smoothly.

A vehicle control device, a vehicle control method, and a storage medium according to the present invention adopt the following configurations.

(1) According to an aspect of the present invention, a vehicle control device includes: a recognizer configured to recognize a surrounding situation of an own vehicle; and a driving controller configured to control a speed and steering of the own vehicle based on a recognition result of the recognizer. In a case in which the own vehicle is traveling in a third lane connected to a first lane of a main lane including at least the first lane and a second lane adjacent to the first lane and enters the first lane, the driving controller is configured to determine that the own vehicle is able to join the first lane when another vehicle traveling on a side of the own vehicle is travelling in the first lane is predicted to change a lane to the second lane, and the driving controller is configured to determine that the own vehicle is not able to join the first lane when the other vehicle is predicted not to change the lane to the second lane and the other vehicle is not decelerating or accelerating. The driving controller is configured to control the own vehicle according to a determination result.

(2) In the vehicle control device according to the aspect (1), the driving controller may determine that the own vehicle is able to join the first lane when the other vehicle is predicted not to change the lane to the second lane and the other vehicle is decelerating or accelerating.

(3) In the vehicle control device according to the aspect (1) or (2), the driving controller may determine whether the own vehicle is able to join the first lane according to an intention to change the lane of the other vehicle before the own vehicle passes a predetermined position set using a specific position at which a vehicle traveling in the third lane is able to change a lane from the third lane to the first lane as a standard. The driving controller may determine whether the own vehicle is able to join the first lane according to a deceleration state or an acceleration state of the other vehicle after the own vehicle passes the predetermined position.

(4) In the vehicle control device according to any one of the aspects (1) to (3), the driving controller may control the own vehicle such that the own vehicle approaches the first lane when the own vehicle is predicted not to be able to join the first lane.

(5) In the vehicle control device according to any one of the aspects (1) to (4), when the own vehicle is determined not to able to join the first lane, the driving controller may control the own vehicle such that a position of the own vehicle is displaced with respect to a position of the other vehicle in traveling directions of the own vehicle and the other vehicle.

(6) In the vehicle control device according to any one of the aspects (1) to (5), when the recognizer is configured to recognize another vehicle traveling in parallel with the own vehicle in the first lane, the driving controller may predict at a first probability that the other vehicle will change the lane to the second lane. The driving controller may perform control according to a prediction result.

(7) In the vehicle control device according to any one of the aspects (1) to (6), the driving controller may predict at a second probability that the other vehicle will change the lane to the second lane when the other vehicle continues traveling in parallel with the own vehicle for a predetermined distance or a predetermined time. The driving controller may perform control according to a prediction result. The second probability may be a probability higher than the first probability that the other vehicle will change the lane to the second lane when the recognizer is configured to recognize the other vehicle traveling in parallel with the own vehicle in the first lane.

(8) In the vehicle control device according to any one of the aspects (1) to (7), the driving controller may predict at a third probability that the other vehicle will change the lane when the own vehicle and the other vehicle are traveling in parallel at a specific position at which a vehicle traveling in the third lane is able to change a lane from the third lane to the first lane. The driving controller may perform control according to a prediction result. The third probability may be a probability higher than a second probability that the other vehicle will change the lane to the second lane when the other vehicle continues traveling in parallel with the own vehicle for a predetermined distance or a predetermined time.

(9) In the vehicle control device according to any one of the aspects (1) to (8), when the recognizer is configured to recognize another vehicle traveling in parallel with the own vehicle in the first lane, the own vehicle may continue traveling in parallel with the other vehicle for a predetermined distance or a predetermined time, and the own vehicle and the other vehicle may be traveling in parallel at a specific position at which a vehicle traveling in the third lane is able to change a lane from the third lane to the first lane, the driving controller may predict that a high probability that the other vehicle will change the lane to the second lane. The high probability is higher than a first predetermined probability. The driving controller may control the own vehicle according to a prediction result.

(10) In the vehicle control device according to any one of the aspects (1) to (5), when the recognizer is configured to recognize another vehicle traveling in parallel with the own vehicle in the first lane, the driving controller may predict whether the other vehicle will change the lane to the second lane.

(11) In the vehicle control device according to the aspect (10), when the own vehicle and the other vehicle are traveling in parallel at a specific position at which a vehicle traveling in the third lane is able to change a lane from the third lane to the first lane, the driving controller may continue predicting whether the other vehicle will change the lane to the second lane.

(12) In the vehicle control device according to the aspect (11), when the own vehicle and the other vehicle continue traveling in parallel for the predetermined distance or the predetermined time even after passing the specific position, the other vehicle is predicted not to change a lane to the second lane, and the other vehicle is not decelerating or not accelerating, the driving controller may control the own vehicle such that the own vehicle approaches the first lane.

(13) In the vehicle control device according to any one of the aspects (1) to (12), when the recognizer is configured to recognize another vehicle traveling in parallel with the own vehicle in the first lane, and then the own vehicle and the other vehicle are not traveling in parallel at a specific position at which a vehicle traveling in the third lane is able to change a lane from the third lane to the first lane or the own vehicle and the other vehicle do not continue traveling in parallel for a predetermined distance or a predetermined time at a time point at which the own vehicle passes beyond the specific position, the driving controller may determine that the other vehicle is configured to permit the own vehicle to change the lane and perform control according to a determination result.

(14) In the vehicle control device according to any one of the aspects (1) to (13), when a direction indicator of the other vehicle represents a change in the lane to the second lane or the other vehicle is predicted to behave to change a lane to the second lane, the driving controller may determine a high probability that the other vehicle will change the lane to a different lane from a lane to which the own vehicle is scheduled to change the lane. The high probability is higher than a second predetermined probability. The driving controller may control the own vehicle according to a determination result.

(15) According to another aspect of the present invention, there is provided a vehicle control method causing a computer to perform: recognizing a surrounding situation of an own vehicle; controlling a speed and steering of the own vehicle according to a recognition result; causing the own vehicle to travel in a third lane connected to a first lane of a main lane including at least the first lane and a second lane adjacent to the first lane; determining that the own vehicle is able to join the first lane when another vehicle traveling on a side of the own vehicle in the first lane is predicted to change a lane to the second lane in a case in which the own vehicle enters the first lane; determining that the own vehicle is not able to join the first lane when the other vehicle is predicted not to change the lane to the second lane and the other vehicle is not decelerating or accelerating; and controlling the own vehicle according to a determination result.

(16) According to still another aspect of the present invention, a computer-readable non-transitory storage medium stores a computer program to be executed by a computer to perform at least: recognizing a surrounding situation of an own vehicle; controlling a speed and steering of the own vehicle according to a recognition result; causing the own vehicle to travel in a third lane connected to a first lane of a main lane including at least the first lane and a second lane adjacent to the first lane; determining that the own vehicle is able to join the first lane when another vehicle traveling on a side of the own vehicle in the first lane is predicted to change a lane to the second lane in a case in which the own vehicle enters the first lane; determining that the own vehicle is not able to join the first lane when the other vehicle is predicted not to change the lane to the second lane and the other vehicle is not decelerating or accelerating; and controlling the own vehicle according to a determination result.

According to the aspects (1), (2), (3), and (12) to (16), when the other vehicle traveling on the side of the own vehicle in the first lane is predicted to change the lane to the second lane, the vehicle control device is configured to determine that the own vehicle is able to join the first lane. When the other vehicle is predicted not to change the lane to the second lane and the other vehicle is not decelerating or accelerating, the vehicle control device is configured to determine that the own vehicle is not able to join the first lane. By controlling the vehicle according to the determination result, it is possible to cause the vehicle to join the main lane smoothly.

According to the aspect (4), when the own vehicle is determined not to able to join the first lane, the vehicle control device expresses an intention to change the lane of the own vehicle to the other vehicle to prompt the other vehicle to permit the change in the lane of the own vehicle by controlling the own vehicle such that the own vehicle approaches the first lane.

According to the aspect (5), when the own vehicle is determined not to able to join the first lane, the vehicle control device can cause the own vehicle to change the lane to a space in front of or behind the other vehicle smoothly by controlling the own vehicle such that a position of the own vehicle is displaced with respect to a position of the other vehicle in the traveling directions of the own vehicle and the other vehicle.

According to the aspects (6) to (8), the vehicle control device can realize control in accordance with surrounding environment and a road in which the own vehicle is traveling and perform a process prepared for a future situation by deriving a probability that the other vehicle changes its lane according to a relation between the own vehicle and the other vehicle and controlling the vehicle according to the probability.

According to the aspect (9), when various conditions are satisfied, the vehicle control device can predict a probability that the other vehicle will change its lane with higher precision by predicting that the probability that the other vehicle changes its lane to the second lane is high.

According to the aspect (10) or (11), when the own vehicle and the other vehicle are traveling in parallel, the vehicle control device is configured to predict whether the other vehicle changes its lane to the second lane. The vehicle control device can realize control further in accordance with a surrounding environment by using the prediction result for the control of the own vehicle.

### BRIEF DESCRIPTION OF THE DRAWINGS

FIG. 1 is a diagram showing a configuration of a vehicle system in which a vehicle control device according to a first embodiment is used.

FIG. 2 is a diagram showing a functional configuration of a first controller and a second controller.

FIG. 3 is a diagram (part 1) showing a behavior of an own vehicle when the own vehicle changes its lane.

FIG. 4 is a diagram (part 2) showing a behavior of the own vehicle when the own vehicle changes its lane.

FIG. 5 is a diagram (part 3) showing a behavior of the own vehicle when the own vehicle changes its lane.

FIG. 6 is a diagram (part 4) showing a behavior of the own vehicle when the own vehicle changes its lane.

FIG. 7 is a flowchart showing an example of a flow of a process performed by an automated driving control device.

FIG. 8 is a diagram showing an example of a functional configuration of first and second controllers according to a second embodiment.

FIG. 9 is a diagram showing a probability derived by a deriver.

FIG. 10 is a diagram showing an example of a hardware configuration of the automated driving control device according to an embodiment.

### DETAILED DESCRIPTION OF EMBODIMENTS

Hereinafter, an embodiment of a vehicle control device, a vehicle control method, and a storage medium according to the present invention will be described with reference to the drawings. Hereinafter, countries or areas where laws and regulations for left-hand traffic are applied will be assumed in description. However, when laws and regulations for right-hand traffic are applied, the left and right may be reversed.

### First Embodiment

### [Overall Configuration]

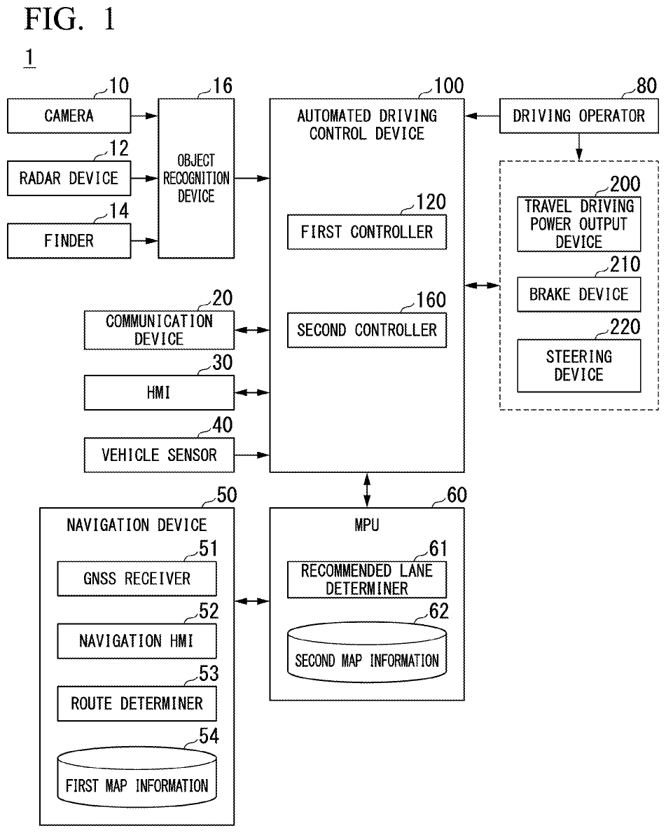

FIG. 1 is a diagram showing a configuration of a vehicle system 1 in which a vehicle control device according to a first embodiment is used. A vehicle in which the vehicle system 1 is mounted is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, or a combination thereof. The electric motor operates using power generated by a power generator connected to the internal combustion engine or power discharged from a secondary cell or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a travel driving power output device 200, a brake device 210, and a steering device 220. The devices and units are connected to one another via a multiplex communication line such as a controller area network (CAN) communication line, a serial communication line, or a wireless communication network. The configuration shown in FIG. 1 is merely an exemplary example, a part of the configuration may be omitted, and another configuration may be further added.

The camera 10 is, for example, a digital camera that uses a solid-state image sensor such as a charged coupled device (CCD) or a complementary metal oxide semiconductor (CMOS). The camera 10 is mounted on any portion of a vehicle in which the vehicle system 1 is mounted (hereinafter referred to as an own vehicle M). When the camera 10 images a front side, the camera 10 is mounted on an upper portion of a front windshield, a rear surface of a rearview mirror, or the like. When the camera 10 images a rear side, the camera 10 is mounted on an upper portion of a rear windshield or the like. For example, the camera 10 repeatedly images the surroundings of the own vehicle M periodically. The camera 10 may be a stereo camera.

The radar device 12 radiates radio waves such as millimeter waves to the surroundings of the own vehicle M and detects radio waves (reflected waves) reflected from an object to detect at least a position (a distance from and an azimuth of) of the object. The radar device 12 is mounted on any portion of the own vehicle M. The radar device 12 may detect a position and a speed of an object in conformity with a frequency modulated continuous wave (FM-CW) scheme.

The finder 14 is a light detection and ranging (LIDAR) finder. The finder 14 radiates light to the surroundings of the own vehicle M and measures scattered light. The finder 14 detects a distance to a target based on a time from light emission to light reception. The radiated light is, for example, pulsed laser light. The finder 14 is mounted on any portions of the own vehicle M.

The object recognition device 16 performs a sensor fusion process on detection results from some or all of the camera 10, the radar device 12, and the finder 14 and recognizes a position, a type, a speed, and the like of an object. The object recognition device 16 outputs a recognition result to the automated driving control device 100. The object recognition device 16 may output detection results of the camera 10, the radar device 12, and the finder 14 to the automated driving control device 100 without any change. The object recognition device 16 may be excluded from the vehicle system 1.

The communication device 20 communicates with another vehicle around the own vehicle M using, for example, a cellular network, a Wi-Fi network, Bluetooth (registered trademark), dedicated short range communication (DSRC) or the like or communicates with various server devices via radio base stations.

The HMI 30 presents various types of information to occupants of the own vehicle M and receives input operations by the occupants. The HMI 30 includes various display devices, speakers, buzzers, touch panels, switches, and keys.

The vehicle sensor 40 includes a vehicle speed sensor that detects a speed of the own vehicle M, an acceleration sensor that detects acceleration, a yaw rate sensor that detects angular velocity around a vertical axis, and an azimuth sensor that detects a direction of the own vehicle M.

The navigation device 50 includes, for example, a global navigation satellite system (GNSS) receiver 51, a navigation HMI 52, and a route determiner 53. The navigation device 50 retains first map information 54 in a storage device such as a hard disk drive (HDD) or a flash memory. The GNSS receiver 51 specifies a position of the own vehicle M based on signals received from GNSS satellites. The position of the own vehicle M may be specified or complemented by an inertial navigation system (INS) using an output of the vehicle sensor 40. The navigation HMI 52 includes a display device, a speaker, a touch panel, and a key. The navigation HMI 52 may be partially or entirely common to the above-described HMI 30. The route determiner 53 determines, for example, a route from a position of the own vehicle M specified by the GNSS receiver 51 (or any input position) to a destination input by an occupant using the navigation HMI 52 (hereinafter referred to as a route on a map) with reference to the first map information 54. The first map information 54 is, for example, information in which a road shape is expressed by links indicating roads and nodes connected by the links. The first map information 54 may include curvatures of roads and point of interest (POI) information. The route on the map is output to the MPU 60. The navigation device 50 may perform route guidance using the navigation HMI 52 based on the route on the map. The navigation device 50 may be realized by, for example, a function of a terminal device such as a smartphone or a tablet terminal possessed by an occupant. The navigation device 50 may transmit a present position and a destination to a navigation server via the communication device 20 to acquire the same route as the route on the map from the navigation server.

The MPU 60 includes, for example, a recommended lane determiner 61 and retains second map information 62 in a storage device such as an HDD or a flash memory. The recommended lane determiner 61 divides the route on the map provided from the navigation device 50 into a plurality of blocks (for example, divides the route in a vehicle movement direction for each 100 [m]) and determines a recommended lane for each block with reference to the second map information 62. The recommended lane determiner 61 determines in which lane the vehicle travels from the left. When there is a branching location in the route on the map, the recommended lane determiner 61 determines a recommended lane so that the own vehicle M can travel in a reasonable route to move to a branching destination.

The second map information 62 is map information that has higher precision than the first map information 54. The second map information 62 includes, for example, information regarding the middles of lanes or information regarding boundaries of lanes. The second map information 62 may include road information, traffic regulation information, address information (address and postal number), facility information, and telephone number information. The second map information 62 may be updated frequently by communicating with another device using the communication device 20.

The driving operator 80 includes, for example, an accelerator pedal, a brake pedal, a shift lever, a steering wheel, a heteromorphic steering wheel, a joystick, a turn signal lever, a microphone, and various switches. A sensor that detects whether there is an operation or an operation amount is mounted in the driving operator 80 and a detection result is output to the automated driving control device 100 or some or all of the travel driving power output device 200, the brake device 210, and the steering device 220.

The automated driving control device 100 includes, for example, a first controller 120 and a second controller 160. Each of the first controller 120 and the second controller 160 is realized, for example, by causing a hardware processor such as a central processing unit (CPU) to execute a program (software). Some or all of the constituent elements may be realized by hardware (a circuit unit including circuitry) such as a large scale integration (LSI), an application specific integrated circuit (ASIC), a field-programmable gate array (FPGA), or a graphics processing unit (GPU) or may be realized by software and hardware in cooperation. The program may be stored in advance in a storage device such as an HDD or a flash memory or may be stored in a detachably mounted storage medium such as a DVD, a CD-ROM, or the like so that the storage medium is mounted on a drive device to be installed on the HDD or the flash memory of the automated driving control device 100.

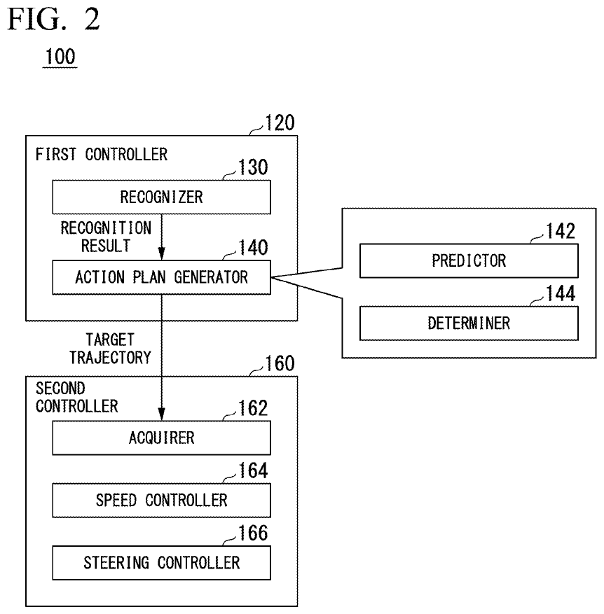

FIG. 2 is a diagram showing a functional configuration of the first controller 120 and the second controller 160. The first controller 120 includes, for example, a recognizer 130 and an action plan generator 140. The recognizer 130 realizes, for example, a function by artificial intelligence (AI) and a function by a model given in advance in parallel. For example, a function of “recognizing an intersection” may be realized by performing recognition of an intersection by deep learning or the like and recognition based on a condition given in advance (a signal, a road sign, or the like which can be subjected to pattern matching) in parallel, scoring both the recognitions, and performing evaluation comprehensively. Thus, reliability of automated driving is guaranteed.

The recognizer 130 recognizes states such as a position, a speed, acceleration, or the like of an object near the own vehicle M based on information input from the camera 10, the radar device 12, and the finder 14 via the object recognition device 16. The object includes another vehicle. For example, the position of the object is recognized as a position on the absolute coordinates in which a representative point (a center of gravity, a center of a driving shaft, or the like) of the own vehicle M is the origin and is used for control. The position of the object may be represented as a representative point such as a center of gravity, a corner, or the like of the object or may be represented as expressed regions. A “state” of an object may include acceleration or jerk of the object or an “action state” (for example, whether a vehicle is changing a lane or is attempting to change the lane).

The recognizer 130 recognizes, for example, a lane in which the vehicle M is traveling (a traveling lane). For example, the recognizer 130 recognizes the traveling lane by comparing patterns of road mark lines (for example, arrangement of continuous lines and broken lines) obtained from the second map information 62 with patterns of road mark lines around the vehicle M recognized from images captured by the camera 10. The recognizer 130 may recognize a traveling lane by recognizing runway boundaries (road boundaries) including road mark lines or shoulders, curbstones, median strips, and guardrails without being limited to road mark lines. In this recognition, the position of the vehicle M acquired from the navigation device 50 or a process result by INS may be added. The recognizer 130 recognizes temporary stop lines, obstacles, red signals, toll gates, and other road events.

The recognizer 130 recognizes a position or a posture of the own vehicle M in the traveling lane when the recognizer 130 recognizes the traveling lane. For example, the recognizer 130 may recognize a deviation from the middle of a lane of the representative point of the own vehicle M and an angle formed with a line extending along the middle of a lane in the traveling direction of the own vehicle M as a relative position and posture of the own vehicle M to the traveling lane. Instead of this, the recognizer 130 may recognize a position or the like of the representative point of the own vehicle M with respect to any side end portion (a road mark line or a road boundary) of a traveling lane as the relative position of the own vehicle M to the traveling lane.

The action plan generator 140 generates a target trajectory along which the own vehicle M travels in future automatedly (irrespective of an operation or the like by a driver) so that the own vehicle M is traveling along a recommended lane determined by the recommended lane determiner 61 and can handle a surrounding situation of the own vehicle M in principle. The target trajectory includes, for example, a speed component. For example, the target trajectory is expressed by arranging spots (trajectory points) at which the own vehicle M will arrive in sequence. The trajectory point is a spot at which the own vehicle M will arrive for each predetermined traveling distance (for example, about several [m]) in a distance along a road. Apart from the trajectory points, target acceleration and a target speed are generated as parts of the target trajectory for each of predetermined sampling times (for example, about every fractions of a second). The trajectory point may be a position at which the own vehicle M will arrive at the sampling time for each predetermined sampling time. In this case, information regarding the target acceleration or the target speed is expressed according to an interval between the trajectory points.

The action plan generator 140 may set an automated driving event when the target trajectory is generated. As the automated driving event, there are a constant speed traveling event, a following traveling event in which a vehicle follows a front vehicle m at a predetermined vehicle speed (for example, 60 [km]) or less, a lane changing event, a branching event, a joining event, a takeover event, and the like. The action plan generator 140 generates the target trajectory in accordance with an activated event.

The action plan generator 140 includes, for example, a predictor 142 and a determiner 144. The predictor 142 predicts whether another vehicle changes its lane (whether another vehicle has an intention to change its lane). The predictor 142 predicts whether the other vehicle changes its lane, for example, based on a blinking state of a direction indicator of the other vehicle, a direction of a central axis of the other vehicle, or the like. For example, the predictor 142 may predict that the other vehicle changes its lane when the direction indicator of the other vehicle blinks, or may predict that the other vehicle changes its lane when the direction indicator blinks and the central axis of the other vehicle is oriented in the direction of a lane of the lane changing destination. Based on a prediction result of the predictor 142, the determiner 144 determines whether the other vehicle changes its lane.

The second controller 160 controls the travel driving power output device 200, the brake device 210, and the steering device 220 so that the own vehicle M passes along the first trajectory generated by the action plan generator 140 at a scheduled time. A combination of the action plan generator 140 and the second controller 160 is an example of a “driving controller.”

The second controller 160 includes, for example, an acquirer 162, a speed controller 164, and a steering controller 166. The acquirer 162 acquires information regarding a target trajectory (trajectory points) generated by the action plan generator 140 and stores the information in a memory (not shown). The speed controller 164 controls the travel driving power output device 200 or the brake device 210 based on a speed element incidental to the target trajectory stored in the memory. The steering controller 166 controls the steering device 220 in accordance with a curve state of the target trajectory stored in the memory. Processes of the speed controller 164 and the steering controller 166 are realized, for example, by combining feed-forward control and feedback control. For example, the steering controller 166 performs the feed-forward control in accordance with a curvature of a road in front of the own vehicle M and the feedback control based on separation from the target trajectory in combination.

The travel driving power output device 200 outputs a travel driving power (torque) for traveling the own vehicle M to a driving wheel. The travel driving power output device 200 includes, for example, a combination of an internal combustion engine, an electric motor, and a transmission and an ECU controlling them. The ECU controls the foregoing configuration in accordance with information input from the second controller 160 or information input from the driving operator 80.

The brake device 210 includes, for example, a brake caliper, a cylinder that transmits a hydraulic pressure to the brake caliper, an electronic motor that generates a hydraulic pressure to the cylinder, and a brake ECU. The brake ECU controls the electric motor in accordance with information input from the second controller 160 or information input from the driving operator 80 such that a brake torque in accordance with a brake operation is output to each wheel. The brake device 210 may include a mechanism that transmits a hydraulic pressure generated in response to an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the second controller 160 such that a hydraulic pressure of the master cylinder is transmitted to the cylinder.

The steering device 220 includes, for example, a steering ECU and an electric motor. The electric motor works a force to, for example, a rack and pinion mechanism to change a direction of a steering wheel. The steering ECU drives the electric motor to change the direction of the steering wheel in accordance with information input from the second controller 160 or information input from the driving operator 80.

### [Changing Lane (Part 1)]

In a case in which the own vehicle M is traveling in a third lane connected to a first lane of a main lane including at least the first lane and a second lane adjacent to the first lane and enters the first lane, the determiner 144 determines that the own vehicle M is able to join the first lane when another vehicle traveling on a side of the own vehicle in the first lane is predicted to change its lane to the second lane. The action plan generator 140 controls the own vehicle M based on the determination result of the determiner 144.

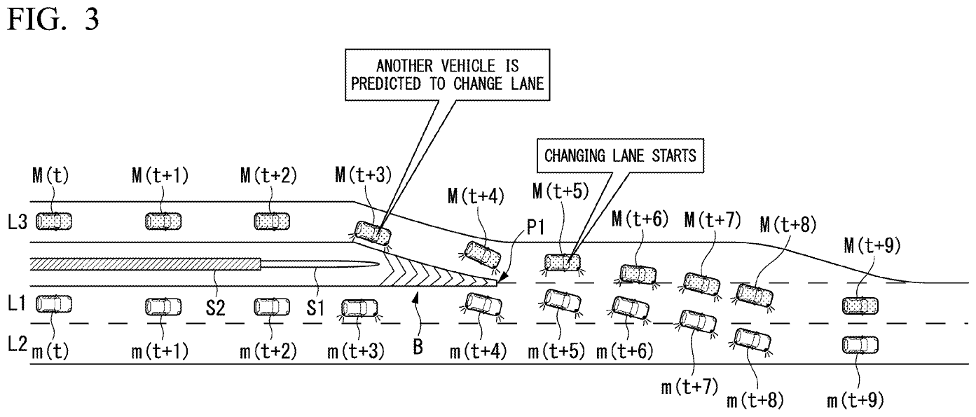

FIG. 3 is a diagram (part 1) showing a behavior of the own vehicle M when the own vehicle M changes its lane. For example, the main lane shown in FIG. 3 includes a first lane L1 and a second lane L2. The first lane L1 of the main lane is connected to a third lane L3 at a specific position P1. The specific position P1 is a starting point of a position at which a vehicle traveling in the third lane L3 is able to change its lane to the first lane L1. The specific position P1 is, for example, an ending point of an entrance prohibition zone B provided on an opposite side (an upstream side) to a traveling direction of the own vehicle M.

On the side upstream from the entrance prohibition zone B, a separation zone S1 separating the first lane L1 from the third lane L3 is provided. On a side upstream from the separation zone S1, a separation zone S2 is provided. The separation zone S1 is a separation zone lower than the separation zone S2. For example, the separation zone S1 has a height at which the own vehicle M traveling in the third lane L3 can recognize another vehicle m traveling in parallel with the own vehicle M over the separation zone S1 in the first lane L1. For example, the separation zone S2 has a height at which the own vehicle M traveling in the third lane L3 cannot recognize the other vehicle m traveling in parallel with the own vehicle M over the separation zone S2 in the first lane L1.

Hereinafter, behaviors of the own vehicle M and the other vehicle m from time t to time t+9 will be described. The own vehicle M is a vehicle that is traveling in the third lane L3 and will change its lane from the third lane L3 to the first lane L1. The other vehicle m is a vehicle that is traveling in the first lane L1 and is traveling in parallel with the own vehicle M until a predetermined time point. Traveling in parallel refers to a state in which at least a part of the own vehicle M overlaps a part of the other vehicle m in traveling directions of the own vehicle M and the other vehicle m and a state in which the own vehicle M and the other vehicle m are traveling.

The own vehicle M and the other vehicle m are traveling in parallel from time t to time t+2. At time t+3, when a direction indicator of the other vehicle m blinks to change the lane to the second lane L2, the predictor 142 predicts that the other vehicle m will change its lane to the second lane L2. At time t+4, the determiner 144 determines that the own vehicle M is able to join the first lane L1. After time t+5, the action plan generator 140 starts changing the lane based on a behavior of the other vehicle m.

When a central axis of the other vehicle m is inclined to change the lane to the second lane L2 at time t+6 and the other vehicle m approaches the second lane L2 at time t+7, the action plan generator 140 inclines the central axis of the own vehicle M to change the lane to the first lane L1 based on the behavior of the other vehicle m and causes the own vehicle M to approach the first lane L1. At time t+8, when the other vehicle m enters the second lane L2, the action plan generator 140 causes the own vehicle M to change its lane to the first lane L1. At time t+9, the other vehicle m is traveling in the second lane L2 and the own vehicle M is traveling in the first lane L1.

In this way, when the other vehicle m traveling in parallel is predicted to change its lane to the second lane L2, the automated driving control device 100 determines that the own vehicle M is able to join the first lane L1 and performs control for joining based on the determination result. As a result, the automated driving control device 100 can cause the own vehicle M to join the main lane smoothly.

### [Changing Lane (Part 2)]

When the other vehicle m is predicted not to change its lane to the second lane L2 and the other vehicle m is decelerating or accelerating (for example, when the other vehicle m is decelerating or accelerating to a predetermined extent or more), the determiner 144 determines that the own vehicle M is able to join the first lane L1. For example, the determiner 144 determines whether the own vehicle M is able to join the first lane L1 based on an intention of the other vehicle m to change its lane before the own vehicle M passes a predetermined position set using the specific position P1 as a standard. The determiner 144 determines whether the own vehicle M is able to join the first lane L1 based on a deceleration state or an acceleration state of the other vehicle m after the own vehicle M passes the predetermined position. The “predetermined position” may be any position as long as the predetermined position is set using the specific position P1 as the standard. The “predetermined position” may be, for example, the specific position P1 itself. The “predetermined position” may be, for example, a position in front of or behind the specific position in the longitudinal direction of the lane. For example, when the deceleration state is the predetermined extent or the acceleration state is the predetermined extent, the own vehicle M is determined to be able to join the first lane L1. The predetermined extent is, for example, a value based on a speed of the own vehicle M or a speed of a nearby vehicle.

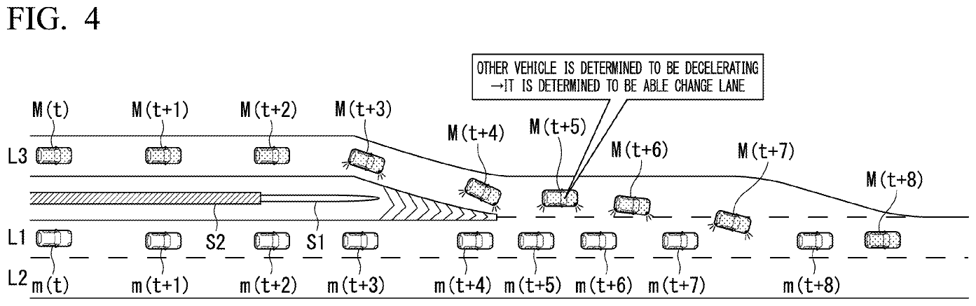

FIG. 4 is a diagram (part 2) showing a behavior of the own vehicle M when the own vehicle M changes its lane. Differences from FIG. 3 will be mainly described. In the example of FIG. 4, a case in which the other vehicle m is decelerating will be described.

At time t+3, the own vehicle M is assumed to blink a direction indicator to represent a change in the lane to the first lane L1. At time t+1 to time t+5, the own vehicle M and the other vehicle m are traveling in parallel. At time t+5, when the other vehicle m is decelerating, the determiner 144 determines that the own vehicle M is able to join the first lane L1. At time t+6, the action plan generator 140 causes the own vehicle M to start changing its lane. At time t+7, the action plan generator 140 causes the own vehicle M to enter in front of the other vehicle m in the first lane L1 based on the behavior of the other vehicle m and change its lane to the first lane L1.

In this way, when the other vehicle m is predicted not to change its lane to the second lane L2 and the other vehicle m is decelerating or accelerating, the automated driving control device 100 determines that the own vehicle M is able to join the first lane L1 and performs control for joining based on the determination result. As a result, even when the other vehicle m does not change its lane, the automated driving control device 100 can cause the own vehicle M to join the main lane smoothly.

### [Changing Lane (Part 3)]

When the other vehicle m is predicted not to change its lane to the second lane L2 and the other vehicle m is not decelerating or accelerating, the determiner 144 determines that the own vehicle M is not able to join the first lane L1. In this case, the action plan generator 140 causes the own vehicle M to approach the first lane L1.

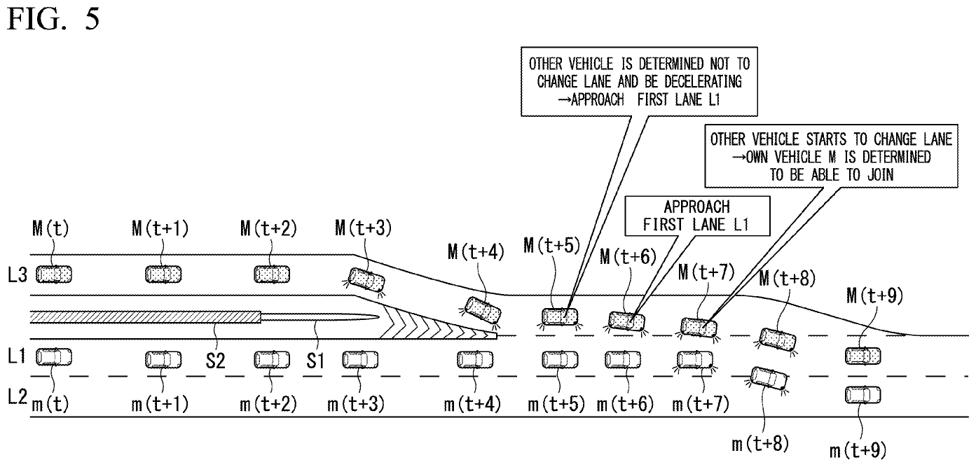

FIG. 5 is a diagram (part 3) showing a behavior of the own vehicle M when the own vehicle M changes its lane. Differences from FIG. 3 will be mainly described.

At time t+1 to time t+5, the own vehicle M and the other vehicle m are traveling in parallel. That is, the other vehicle m is not changing its lane and is not accelerating or decelerating. At time t+6, the own vehicle M approaches the first lane L1. At time t+7, when the other vehicle m starts changing its lane to the second lane L2 or is decelerating or accelerating, as shown in FIG. 5, the determiner 144 determines that the own vehicle M is able to join the first lane L1. At time t+8, the action plan generator 140 causes the own vehicle M to change its lane to the first lane L1 based on a behavior of the other vehicle m.

In this way, when the other vehicle m is predicted not to change its lane to the second lane and the other vehicle m is not decelerating or accelerating, the automated driving control device 100 determines that the own vehicle M is not able to join the first lane. Then, the own vehicle M expresses an intention to change its lane to the first lane L1 to the other vehicle m to prompt the other vehicle m to permit the change in the lane of the own vehicle M by controlling the own vehicle M such that the own vehicle M approaches the first lane L1. Then, when the other vehicle m permits the change in the lane of the own vehicle M, the own vehicle M can change its lane. In this way, the automated driving control device 100 can cause the own vehicle M to change its lane more smoothly.

### [Changing Lane (Part 4)]

When the determiner 144 determines that the own vehicle M is not able to join the first lane L1, the action plan generator 140 controls the own vehicle M such that a position of the own vehicle M is displaced with respect to a position of the other vehicle in the traveling directions of the own vehicle M and the other vehicle m.

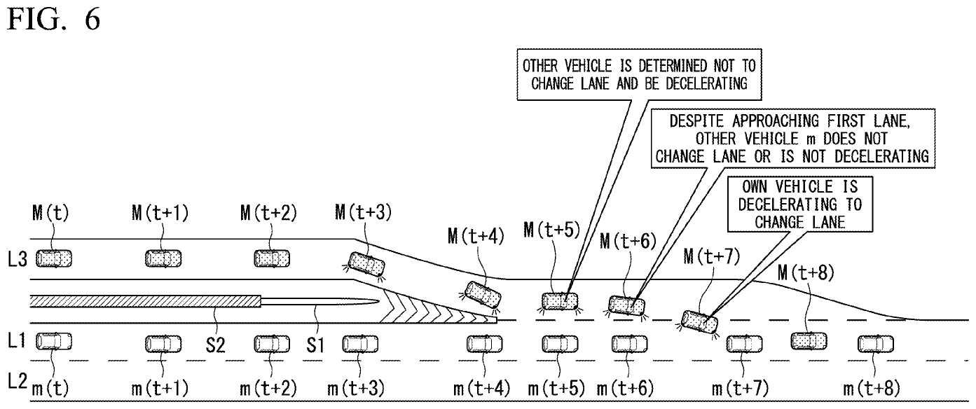

FIG. 6 is a diagram (part 4) showing a behavior of the own vehicle M when the own vehicle M changes its lane. Differences from FIG. 3 will be mainly described.

At time t+1 to time t+5, the own vehicle M and the other vehicle m are traveling in parallel. That is, the other vehicle m continues not to change its lane and not to accelerate or decelerate. At time t+6, even when the own vehicle M approaches the first lane L1, the other vehicle m does not change its lane or is not decelerating. At time t+7, the own vehicle M is decelerating to change its lane behind the other vehicle m in the first lane L1. When the own vehicle M does not perform a process of approaching the first lane L1 before deceleration and continues traveling in parallel with the other vehicle m or the other vehicle m does not change its lane, the own vehicle M may decelerate.

In this way, when the own vehicle M continues traveling in parallel with the other vehicle m, the automated driving control device 100 can avoid the traveling of the own vehicle M in parallel with the other vehicle m and perform control for changing the lane by decelerating or accelerating the own vehicle M. As a result, the automated driving control device 100 can cause the own vehicle M to change the lane more smoothly.

In this way, when the recognizer 130 recognizes the other vehicle m traveling in parallel with the own vehicle M in the first lane L1, the action plan generator 140 predicts whether the other vehicle m changes its lane to the second lane L2. When the own vehicle M and the other vehicle m are traveling in parallel at the specific position P1 at which a vehicle traveling in the third lane L3 can change its lane from the third lane L3 to the first lane L1, the action plan generator 140 continuously determines whether the other vehicle m changes its lane to the second lane L2. When the other vehicle m continues traveling in parallel with the own vehicle M for a predetermined distance or a predetermined time after passing the specific position P1 and the other vehicle m is not decelerating or accelerating after the other vehicle m is predicted not to change its lane to the second lane L2, the action plan generator 140 controls the own vehicle M such that the own vehicle M approaches the first lane L1.

In this way, when there is another vehicle m traveling in parallel with the own vehicle M, the automated driving control device 100 determines that the own vehicle M is able to join the first lane L1 based on a prediction result of whether the other vehicle m changes its lane to the second lane L2 and can cause the own vehicle M to join the main lane smoothly by controlling the vehicle based on a determination result.

### [Flowchart]

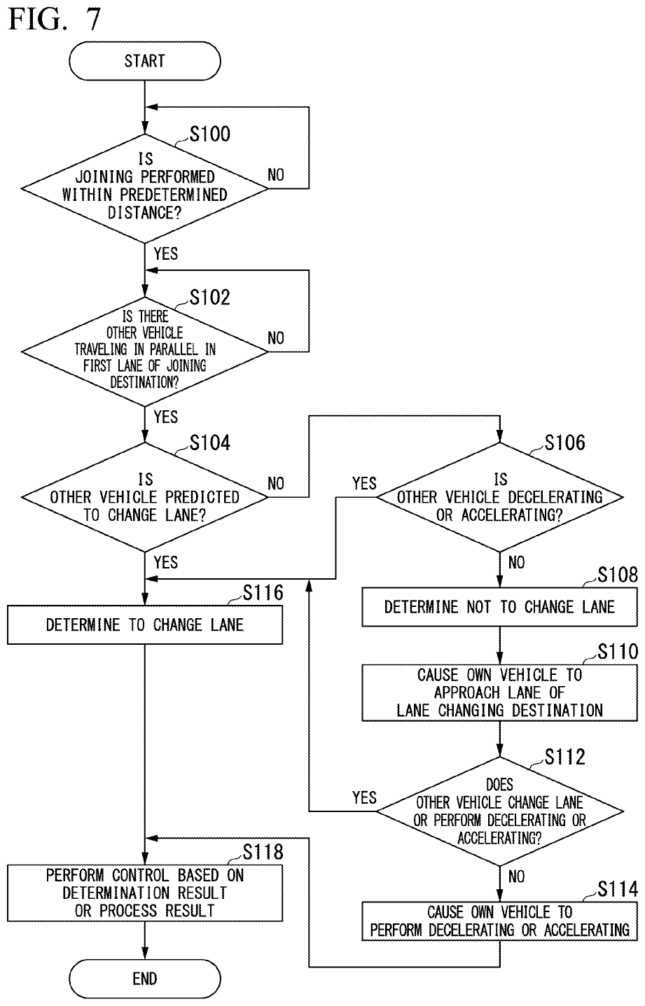

FIG. 7 is a flowchart showing an example of a flow of a process performed by the automated driving control device 100. First, the action plan generator 140 determines whether the own vehicle M is scheduled to perform joining within a predetermined distance from a current position of the own vehicle M (step S100). When the own vehicle M is scheduled to join, the action plan generator 140 determines whether there is another vehicle m traveling in parallel with the own vehicle M in the first lane L1 of a joining destination based on a recognition result of the recognizer 132 (step S102).

When there is another vehicle m traveling in parallel with the own vehicle M, the predictor 142 predicts whether the other vehicle m recognized in step S102 changes its lane (step S104). When the other vehicle m is predicted to change its lane, the determiner 144 determines that the own vehicle M can change its lane to the first lane L1 (step S116). Then, the action plan generator 140 considers a behavior (a position or a speed) of the other vehicle m, a surrounding environment of the own vehicle M, or the like and changes its lane based on the determination result or a process result (step S118). For example, the own vehicle M changes its lane through the behavior shown in FIG. 3, as described above.

When the other vehicle m is predicted not to change its lane, the action plan generator 140 determines whether the other vehicle m is decelerating or accelerating (step S106). When the other vehicle m is decelerating or accelerating, the determiner 144 determines that the own vehicle M can change its lane to the first lane L1 (step S116). Then, the process proceeds to step S116. For example, the own vehicle M changes its lane through the behavior shown in FIG. 4, as described above.

When the other vehicle m is not decelerating or accelerating, the determiner 144 determines that the own vehicle M cannot change its lane to the first lane L1 (step S108). When the determiner 144 determines that the own vehicle M cannot change its lane to the first lane L1, the action plan generator 140 causes the own vehicle M to approach the first lane L1 (step S110). In the state in which the own vehicle M approaches the first lane L1, the action plan generator 140 determines whether the other vehicle m changes its lane or is decelerating or accelerating (step S112). When the other vehicle m changes its lane or performs decelerating or accelerating, the process proceeds to step S116.

When the other vehicle m does not change its lane or does not perform decelerating or accelerating, the action plan generator 140 causes the own vehicle M to perform decelerating or accelerating (step S114). Then, the action plan generator 140 performs the lane changing by controlling the own vehicle M such that a position of the own vehicle M is displaced with respect to a position of the other vehicle m in the traveling directions of the own vehicle M and the other vehicle m (step S118). For example, the own vehicle M changes the lane through the behavior shown in FIG. 6, as described above. Then, the process of the flowchart ends.

For example, when there is another vehicle m traveling in parallel, this state continues and the other vehicle M cannot change its lane smoothly in some cases. In the embodiment, however, the automated driving control device 100 can cause the own vehicle M to join the main lane smoothly by performing control based on a relation between the other vehicle m and the own vehicle M.

At the time of joining, the automated driving control device 100 predicts that the other vehicle m has an intention to permit the change in the lane of the own vehicle M based on a state of the other vehicle m traveling in parallel from the front of an actual joining position (in the front of an actual joining position). In this determination, the automated driving control device 100 determines whether there is a change in the lane in which the intention to first permit the change in the lane is clear. When the other vehicle m is determined not to change its lane, the determination for the change in the lane ends and the other vehicle m is determined to be decelerating or accelerating at a time point at which a remaining portion of the third lane L3 which is a joining road decreases. With regard to the deceleration or the acceleration of the other vehicle m, it is difficult to understand beforehand whether the own vehicle M is permitted to change its lane or a deceleration or acceleration speed is simply controlled, but it is easy to predict an intention of the other vehicle m near the ending point of the joining road. In this way, the automated driving control device 100 can cause the own vehicle M to join the main lane smoothly by appropriately determining joining or non-joining step by step and controlling the own vehicle M based on the determination result.

According to the above-described first embodiment, when the other vehicle m traveling on a side of the own vehicle M in the first lane L1 is predicted to change its lane to the second lane L2, the automated driving control device 100 determines that the own vehicle M is able to join the first lane L1. When the other vehicle m is predicted not to change its lane to the second lane L2, the other vehicle m is not decelerating or accelerating, and the own vehicle M is determined not to be able to join the first lane L1, the automated driving control device 100 can cause the own vehicle M to join the main lane smoothly by controlling the vehicle based on the determination result.

### Second Embodiment

A second embodiment will be described. In the second embodiment, the predictor 142 derives a probability that the other vehicle m will change its lane based on a relative relation between the own vehicle M and the other vehicle m. Then, based on a derivation result of the deriver 143, the determiner 144 determines whether the other vehicle m changes its lane. Hereinafter, differences from the first embodiment will be mainly described.

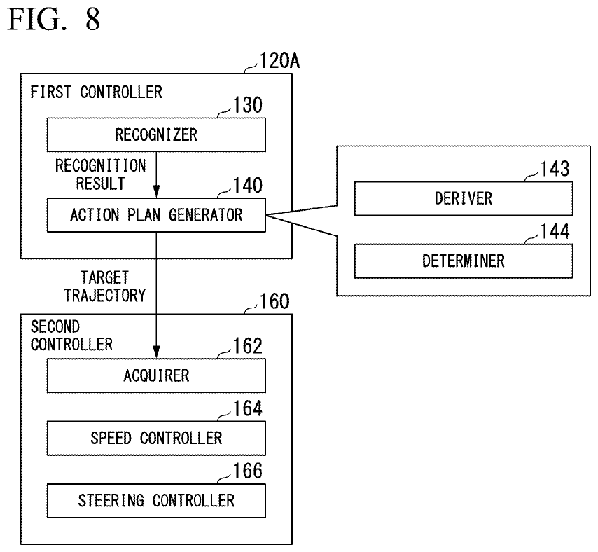

FIG. 8 is a diagram showing an example of a functional configuration of a first controller 120A and a second controller 160 according to the second embodiment. The first controller 120A according to the second embodiment includes a deriver 143 instead of the predictor 142. Based on a relative relation between the own vehicle M and the other vehicle m, the deriver 143 derives a probability that the other vehicle m will change its lane.

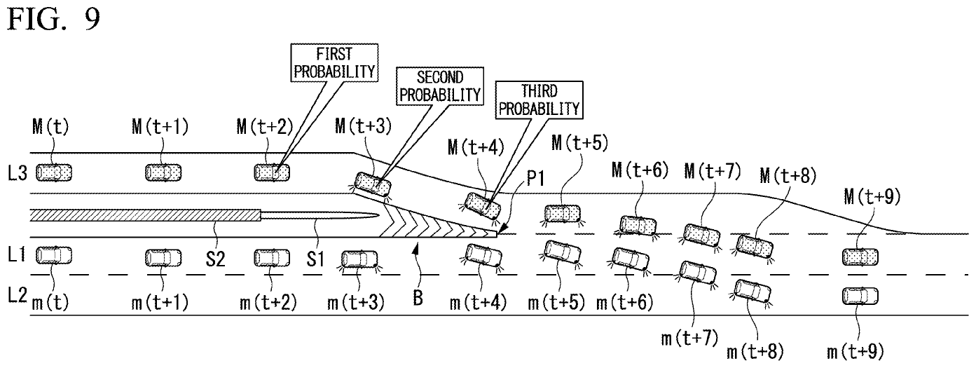

FIG. 9 is a diagram showing a probability derived by the deriver 143. Differences from FIG. 3 described above will be mainly described. At time t+2, when the recognizer 130 recognizes the other vehicle m traveling in parallel with the own vehicle M in the first lane L1, the deriver 143 predicts a first probability (for example, a probability of 20 to 30%) that the other vehicle m will change its lane to the second lane L2. Then, the action plan generator 140 performs control based on the prediction result of the predictor 142. For example, at time t+5 to t+7 or the like, the action plan generator 140 generates a trajectory in which the own vehicle M approaches the first lane L1 or a trajectory in which the own vehicle M is decelerating or accelerating and generates a trajectory to change the lane without interfering with the other vehicle m. For example, the action plan generator 140 assumes that the own vehicle M will continue traveling in parallel with the other vehicle m and generates a trajectory based on the assumption result. In this way, the own vehicle M prepares beforehand for a case in which traveling in parallel continues.

At time t+3, when the other vehicle continues traveling in parallel with the own vehicle for a predetermined distance or a predetermined time (when the traveling in parallel continues from time t+2 to time t+3), the deriver 143 predicts a second probability (a probability greater than 30% to 95%) that the other vehicle m will change its lane to the second lane L2. The second probability is a probability higher than the first probability.

For example, when the other vehicle continues traveling in parallel with the own vehicle for the predetermined distance or the predetermined time, the predictor 142 may considers the blinking state of the direction indicator of the other vehicle m or the direction of the central axis of the other vehicle m and derive the second probability. For example, (1) when the other vehicle continues traveling in parallel with the own vehicle for the predetermined distance or the predetermined time, a 2A-th probability is derived. (2) When the direction indicator blinks to change the lane to the second lane L2 in addition to the above (1), a 2B-th probability is derived. (3) When the central axis of the other vehicle m is oriented in the direction of the second lane L2 in addition to the above (1) and (2), a 2C-th probability is derived. The probabilities are higher in the order of the 2C-th probability, the 2B-th probability, and the 2A-th probability. The 2B-th probability may be derived in a case in which the above (1) and (3) are satisfied instead of a case in which the above (1) and (2) are satisfied.

Then, the action plan generator 140 performs control based on a prediction result of the predictor 142. For example, the action plan generator 140 generates a trajectory to change the lane instead of (or in addition to) the trajectory generated when the first probability is derived at time t+5 to t+7 or the like. For example, the action plan generator 140 assumes that the other vehicle m provides a space necessary for the own vehicle M to change the lane and generates a trajectory based on the assumption result.

At time t+4, when the own vehicle M and the other vehicle m are traveling in parallel at the specific position P1 at which a vehicle traveling in the third lane L3 can change its lane from the third lane L3 to the first lane L1 (when the traveling in parallel continues from time t+2 to time t+4), the predictor 142 predicts a third probability (a probability greater than 95%) that the other vehicle m will change its lane higher than the second probability that the other vehicle m will change its lane to the second lane L2. The third probability is a probability higher than the second probability.

For example, the predictor 142 may considers (2) the blinking state of the direction indicator of the other vehicle m or (3) the direction of the central axis of the other vehicle m, as described above, and derive the third probability. For example, (1 #) when the own vehicle M and the other vehicle m are traveling in parallel at the specific position P1 at which the vehicle traveling in the third lane L3 can change its lane from the third lane L3 to the first lane L1, a 3A-th probability is derived. When the direction indicator blinks to change the lane to the second lane L2 in addition to the above (1 #), a 3B-th probability is derived. (3) When the central axis of the other vehicle m is oriented in the direction of the second lane L2 in addition to the above (1 #) and (2), a 3C-th probability is derived. The probabilities are higher in the order of the 3C-th probability, the 3B-th probability, and the 3A-th probability. The 3B-th probability may be derived in a case in which the above (1) and (3) are satisfied instead of a case in which the above (1) and (2) are satisfied.

The action plan generator 140 performs control based on the prediction result of the predictor 142. For example, when the third probability is derived, the action plan generator 140 generates a trajectory to change the lane instead of (or in addition to) the trajectory generated when the first probability or the second probability is derived at time t+5 to t+7 or the like. For example, the action plan generator 140 assumes that the other vehicle m provides a space necessary for the own vehicle M to change the lane and generates a trajectory based on the assumption result. For example, when the third probability is derived, the action plan generator 140 generates a more specific trajectory to change the lane than the trajectory generated when the second probability is derived. The specific trajectory to change the lane is, for example, a trajectory in which a behavior (a behavior such as a change in the lane, deceleration, or acceleration) of the other vehicle m is considered.

The own vehicle M changes its lane based on the trajectory generated by the action plan generator 140 in this way.

For example, the action plan generator 140 predicts a high probability that the other vehicle m will change its lane to the second lane L2 (or a probability that the own vehicle M will be permitted to change its lane) (A) when the recognizer 130 recognizes the other vehicle traveling in parallel with the other vehicle M in the first lane L1 as at time t+2, (B) when the other vehicle m continues traveling in parallel with the own vehicle M for the predetermined distance or the predetermined time as in time t+3, and (C) when the own vehicle M and the other vehicle m are traveling in parallel at the specific position P1 as at time t+4. When the probability that the other vehicle m will change its lane to the second lane L2 is high, an index indicating that the lane can be changed is determined to be equal to or greater than a threshold and the action plan generator 140 performs the lane changing based on a state of the other vehicle m, a surrounding environment, or the like.

For example, when none of the conditions (A) to (C) is satisfied or when one or more of the conditions (A) to (C) are not satisfied, the automated driving control device 100 may predict a low probability that the other vehicle m will change its lane, the own vehicle M may perform decelerating to change its lane behind the other vehicle m or the own vehicle M may perform accelerating to change its lane in front of the other vehicle m.

For example, when one or more of the above (A), (B), and (C) are satisfied, the action plan generator 140 may predict a high probability that the other vehicle m will change its lane to the second lane L2 (or a high probability that the own vehicle M will be permitted to change its lane).

When the direction indicator of the other vehicle m blinks to change the lane or the central axis of the other vehicle m is inclined to change the lane in the state in which the own vehicle M and the other vehicle m are traveling in parallel, a probability that the other vehicle m will change its lane is equal to or greater than a threshold may be predicted and it may be determined that the own vehicle M can change its lane.

According to the above-described second embodiment, based on the probability that the other vehicle m will change its lane to the second lane, the automated driving control device 100 can appropriately control the vehicle by determining whether the own vehicle M is able to join the first lane L1 with higher precision.

### [Hardware Configuration]

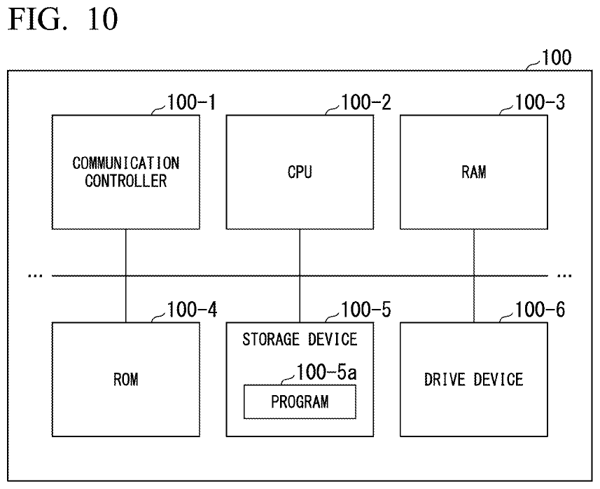

FIG. 10 is a diagram showing an example of a hardware configuration of the automated driving control device 100 according to an embodiment. As shown, the automated driving control device 100 is configured such that a communication controller 100-1, a CPU 100-2, a random access memory (RAM) 100-3 that is used as a working memory, a read-only memory (ROM) 100-4 that stores a boot program or the like, a storage device 100-5 such as a flash memory or a hard disk drive (HDD), a drive device 100-6, and the like are connected to each other via an internal bus or a dedicated communication line. The communication controller 100-1 performs communication with constituent element other than the automated driving control device 100. The storage device 100-5 stores a program 100-5a that is executed by the CPU 100-2. The program is loaded on the RAM 100-3 by a direct memory access (DMA) controller (not shown) to be executed by the CPU 100-2. Thus, some or all of the recognizer 130, the action plan generator 140, and the second controller 160 are realized.

The above-described embodiment can be expressed as follows:

a vehicle control device including a storage device that stores a program and a hardware processor, the hardware processor executing the program stored in the storage device to perform:

recognizing a surrounding situation of an own vehicle;

controlling a speed and steering of the own vehicle based on a recognition result of the recognizer;

determining that the own vehicle is able to join a first lane when another vehicle traveling on a side of the own vehicle in the first lane is predicted to change a lane to a second lane in a case in which the own vehicle is traveling in the third lane connected to the first lane of a main lane including at least the first lane and the second lane adjacent to the first lane and enters the first lane;

determining that the own vehicle is not able to join the first lane when the other vehicle is predicted not to change the lane to the second lane and the other vehicle is not decelerating or accelerating; and

controlling the own vehicle based on a determination result.

While preferred embodiments of the invention have been described and shown above, it should be understood that these are exemplary examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a recognizer configured to recognize a surrounding situation of an own vehicle; and
a driving controller configured to control a speed and steering of the own vehicle according to a recognition result of the recognizer,
wherein, in a case in which the own vehicle is traveling in a third lane connected to a first lane of a main lane including at least the first lane and a second lane adjacent to the first lane and enters the first lane,
the driving controller is configured to determine that the own vehicle is able to join the first lane when another vehicle traveling on a side of the own vehicle in the first lane is predicted to change a lane to the second lane, and
the driving controller is configured to determine that the own vehicle is not able to join the first lane when the other vehicle is predicted not to change the lane to the second lane and the other vehicle is not decelerating or accelerating, and
wherein the driving controller controls the own vehicle according to a determination result.

2. The vehicle control device according to claim 1, wherein the driving controller is configured to determine that the own vehicle is able to join the first lane when the other vehicle is predicted not to change the lane to the second lane and the other vehicle is decelerating or accelerating.

3. The vehicle control device according to claim 1,
wherein the driving controller is configured to determine whether the own vehicle is able to join the first lane according to an intention to change the lane of the other vehicle before the own vehicle passes a predetermined position set using a specific position at which a vehicle traveling in the third lane is able to change a lane from the third lane to the first lane as a standard, and
wherein the driving controller is configured to determine whether the own vehicle is able to join the first lane according to a deceleration state or an acceleration state of the other vehicle after the own vehicle passes the predetermined position.

4. The vehicle control device according to claim 1, wherein the driving controller is configured to control the own vehicle such that the own vehicle approaches the first lane when the own vehicle is predicted not to be able to join the first lane.

5. The vehicle control device according to claim 1, wherein, when the own vehicle is determined not to able to join the first lane, the driving controller is configured to control the own vehicle such that a position of the own vehicle is displaced with respect to a position of the other vehicle in traveling directions of the own vehicle and the other vehicle.

6. The vehicle control device according to claim 1,
wherein, when the recognizer is configured to recognize another vehicle traveling in parallel with the own vehicle in the first lane, the driving controller predicts a first probability that the other vehicle will change the lane to the second lane, and
wherein the driving controller is configured to perform control according to a prediction result.

7. The vehicle control device according to claim 1,
wherein the driving controller predicts a second probability that the other vehicle will change the lane to the second lane when the other vehicle continues traveling in parallel with the own vehicle for a predetermined distance or a predetermined time,
wherein the driving controller is configured to perform control according to a prediction result, and
wherein the second probability is a probability higher than the first probability that the other vehicle will change the lane to the second lane when the recognizer is configured to recognize the other vehicle traveling in parallel with the own vehicle in the first lane.

8. The vehicle control device according to claim 1,
wherein the driving controller is configured to predict a third probability that the other vehicle will change the lane when the own vehicle and the other vehicle are traveling in parallel at a specific position at which a vehicle traveling in the third lane is able to change a lane from the third lane to the first lane,
wherein the driving controller is configured to perform control according to a prediction result, and
wherein the third probability is a probability higher than a second probability that the other vehicle will change the lane to the second lane when the other vehicle continues traveling in parallel with the own vehicle for a predetermined distance or a predetermined time.

9. The vehicle control device according to claim 1,
wherein, when the recognizer recognizes another vehicle traveling in parallel with the own vehicle in the first lane, the own vehicle is configured to continue traveling in parallel with the other vehicle for a predetermined distance or a predetermined time, and the own vehicle and the other vehicle are traveling in parallel at a specific position at which a vehicle traveling in the third lane is able to change a lane from the third lane to the first lane, the driving controller is configured to predict a high probability that the other vehicle will change the lane to the second lane, wherein the high probability is higher than a first predetermined probability, and
wherein the driving controller is configured to control the own vehicle according to a prediction result.

10. The vehicle control device according to claim 1, wherein, when the recognizer is configured to recognize another vehicle traveling in parallel with the own vehicle in the first lane, the driving controller is configured to predict whether the other vehicle will change the lane to the second lane.

11. The vehicle control device according to claim 10, wherein, when the own vehicle and the other vehicle are traveling in parallel at a specific position at which a vehicle traveling in the third lane is able to change a lane from the third lane to the first lane, the driving controller is configured to continue predicting whether the other vehicle will change the lane to the second lane.

12. The vehicle control device according to claim 11, wherein, when the own vehicle and the other vehicle continue traveling in parallel for the predetermined distance or the predetermined time even after passing the specific position, the other vehicle is predicted not to change a lane to the second lane, and the other vehicle is not decelerating or accelerating, the driving controller is configured to control the own vehicle such that the own vehicle approaches the first lane.

13. The vehicle control device according to claim 1,
wherein, when the recognizer is configured to recognize another vehicle traveling in parallel with the own vehicle in the first lane, and then
the own vehicle and the other vehicle are not traveling in parallel at a specific position at which a vehicle traveling in the third lane is able to change a lane from the third lane to the first lane or
the own vehicle and the other vehicle do not continue traveling in parallel for a predetermined distance or a predetermined time at a time point at which the own vehicle passes beyond the specific position,
the driving controller is configured to determine that the other vehicle permits the own vehicle to change the lane and perform control according to a determination result.

14. The vehicle control device according to claim 1,
wherein, when a direction indicator of the other vehicle represents a change in the lane to the second lane or the other vehicle is predicted to behave to change a lane to the second lane, the driving controller is configured to determine a high probability that the other vehicle will change the lane to a different lane from a lane to which the own vehicle is scheduled to change the lane, wherein the high probability is higher than a second predetermined probability, and
wherein the driving controller is configured to control the own vehicle according to a determination result.

15. A vehicle control method causing a computer to perform:
recognizing a surrounding situation of an own vehicle;
controlling a speed and steering of the own vehicle according to a recognition result;
causing the own vehicle to travel in a third lane connected to a first lane of a main lane including at least the first lane and a second lane adjacent to the first lane;
determining that the own vehicle is able to join the first lane when another vehicle traveling on a side of the own vehicle in the first lane is predicted to change a lane to the second lane in a case in which the own vehicle enters the first lane;
determining that the own vehicle is not able to join the first lane when the other vehicle is predicted not to change the lane to the second lane and the other vehicle is not decelerating or accelerating; and
controlling the own vehicle according to a determination result.

16. A non-transitory computer-readable storage medium that is configured to store a computer program to be executed by a computer to perform at least:
recognizing a surrounding situation of an own vehicle;
controlling a speed and steering of the own vehicle according to a recognition result;
causing the own vehicle to travel in a third lane connected to a first lane of a main lane including at least the first lane and a second lane adjacent to the first lane;
determining that the own vehicle is able to join the first lane when another vehicle traveling on a side of the own vehicle in the first lane is predicted to change a lane to the second lane in a case in which the own vehicle enters the first lane;
determining that the own vehicle is not able to join the first lane when the other vehicle is predicted not to change the lane to the second lane and the other vehicle is not decelerating or accelerating; and
controlling the own vehicle according to a determination result.
